(19) United States
(12) Patent Application Publication
(10) Pub. No.: US 2020/0213231 A1
(43) Pub. Date: Jul. 2, 2020

(54) INFORMATION PROCESSING APPARATUS, INFORMATION PROCESSING SYSTEM, AND COMPUTER PROGRAM PRODUCT

(71) Applicant: FUJITSU CLIENT COMPUTING LIMITED, Kanagawa (JP)

(72) Inventor: Kei Kato, Kawasaki (JP)

(73) Assignee: FUJITSU CLIENT COMPUTING LIMITED, Kanagawa (JP)

(21) Appl. No.: 16/697,422

(22) Filed: Nov. 27, 2019

(30) Foreign Application Priority Data
Dec. 28, 2018 (JP) 2018-248326
Dec. 28, 2018 (JP) 2018-248667

(51) Int. Cl. H04L 12/801; H04L 12/26; H04L 12/825

(52) U.S. Cl. CPC H04L 47/11; H04L 47/25; H04L 47/263; H04L 43/16

(57) ABSTRACT

An information processing apparatus includes: a memory and a hardware processor coupled to the memory. The hardware processor: monitors progress condition of AI processing in an AI processing device performing the AI processing; outputs data generated by one or more data generating devices to the AI processing device when it is determined that the AI processing device is not congested; and skips output of the data to the AI processing device when it is determined that the AI processing device is congested.

### CROSS-REFERENCE TO RELATED APPLICATIONS

This application is based upon and claims the benefit of priority from Japanese Patent Applications No. 2018-248667 and No. 2018-248326, both filed on Dec. 28, 2018, the entire contents of all of which are incorporated herein by reference.

### FIELD

Embodiments described herein relate to an information processing apparatus, an information processing system, and a computer program product.

### BACKGROUND

Recently, various kinds of services with artificial intelligence (AI) processing such as object recognition utilizing a deep learning technique, which is a machine learning method, have been provided.

For example, a technique has been disclosed, in which an age of a person in a camera image is discriminated by using the deep learning technique and a suspicious person or the like is automatically specified.

However, when attempting to analyze characteristics of a person who appears in a camera image for each frame with AI processing by using the deep learning technique, the amount of arithmetic operations to be performed may increase in accordance with the number of people. In particular, a problem may arise such that, when an analysis on characteristics of a person who is captured in a camera image in real time is performed, a delay may occur in the analysis processing with AI processing when the amount of arithmetic operations becomes extremely large.

### SUMMARY

An information processing apparatus according to the present disclosure includes a memory and a hardware processor coupled to the memory. The hardware processor is configured to: monitor progress condition of AI processing being artificial intelligence processing in an AI processing device performing the AI processing; output data generated by one or more data generating devices to the AI processing device when it is determined that the AI processing device is not congested; and skip output of the data to the AI processing device when it is determined that the AI processing device is congested.

An information processing system according to the present disclosure includes the information processing apparatus and an AI processing device. The information processing apparatus acquires the data generated by the one or more data generating devices. The AI processing device is configured to perform AI processing being artificial intelligence processing on the data output from the information processing apparatus, the AI processing device performing feedback of a congestion state of AI processing to the information processing apparatus.

A computer program product according to the present disclosure includes a computer-readable recording medium on which an executable program is recorded. The program instructs a computer to: monitor progress condition of AI processing being artificial intelligence processing in an AI processing device performing the AI processing; output data generated by one or more data generating devices to the AI processing device when it is determined, as a result of the monitor, that the AI processing device is not congested; and skip output of the data to the AI processing device when it is determined, as a result of the monitor, that the AI processing device is congested.

### BRIEF DESCRIPTION OF THE DRAWINGS

FIG. 1 is a diagram schematically illustrating a connection configuration of a plurality of platforms in an information processing system according to an embodiment;

FIG. 2 is a diagram schematically illustrating a hardware structure of a platform; and

FIG. 3 is a diagram exemplifying a software configuration of a platform;

FIG. 4 is a diagram schematically illustrating a hardware structure of a PCIe bridge controller;

FIG. 5 is a diagram illustrating a layer configuration of PCIe;

FIG. 6 is a diagram exemplifying how other processors are seen from a processor (processor H);

FIG. 7 is a diagram exemplifying how other processors are seen from a processor (processor E);

FIG. 8 is a diagram for explaining a method of data transfer between processors via the PCIe bridge controller;

FIG. 9 is a functional block diagram illustrating a function in the information processing system;

FIG. 10 is a flowchart illustrating a flow of processing in a platform as an information processing apparatus;

FIG. 11 is a flowchart illustrating a flow of processing that determines a congestion level of an AI processing section;

FIG. 12 is a diagram illustrating an exemplary congestion level table; and

FIG. 13 is a diagram illustrating a display example on a monitor.

### DETAILED DESCRIPTION

Embodiments of an information processing apparatus, an information processing system, and a computer program product will now be described in detail with reference to the drawings.

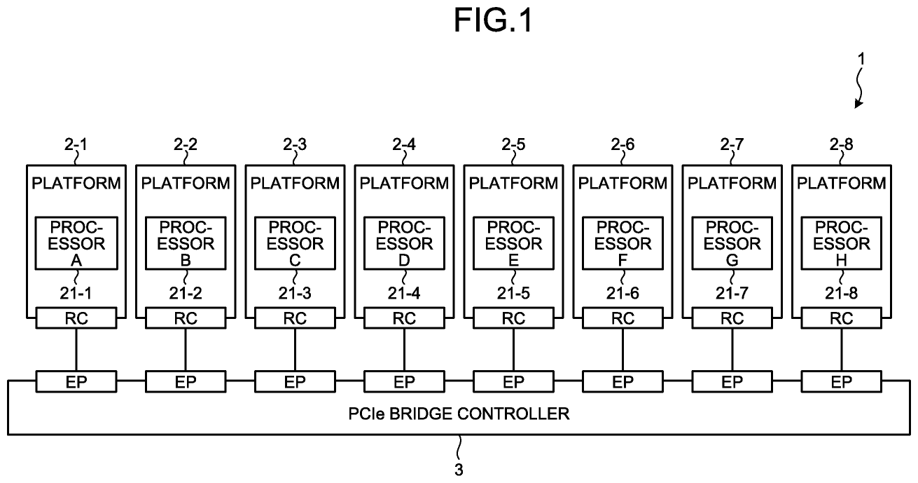

FIG. 1 is a diagram schematically illustrating a connection configuration of a plurality of platforms in an information processing system 1 according to an embodiment.

System Configuration

The information processing system 1 exemplified in FIG. 1 includes a peripheral component interconnect express (PCIe: registered trademark) bridge controller 3 and a plurality (eight in the example illustrated in FIG. 1) of platforms 2-1 to 2-8. The platforms 2-1 to 2-8 are each connected to the PCIe bridge controller 3.

In the following, reference signs 2-1 to 2-8 will be used as the reference sign of a platform when it is needed to specify one of the platforms. Meanwhile, reference sign 2 will be used when indicating any one of the platforms. The platform 2 may be referred to as the PC platform 2.

Platform

The platform 2-1 as an information processing apparatus includes a processor 21-1. Similarly, the platforms 2-2 to 2-8 include processors 21-2 to 21-8, respectively. In PCIe, the processors 21-1 to 21-8 become root complexes (RC) that are capable of operating on the host side, whereas a device equipped on the PCIe bridge controller 3 becomes an endpoint (EP), and data transfer is performed between the host and the device.

The processors 21-1 to 21-8 each may be provided from different manufacturers (or vendors). For example, the processors 21-1, 21-2, 21-3, 21-4, 21-5, 21-6, 21-7, and 21-8 are provided from a company A, a company B, a company C, a company D, a company E, a company F, a company G, and a company H, respectively,

In the following, the processors 21-1, 21-2, 21-3, 21-4, 21-5, 21-6, 21-7, and 21-8 may be referred to as processors A, B, C, D, E, F, G, and H, respectively. In addition, different platforms may be connected to each of EPs equipped on the PCIe bridge controller 3. Furthermore, two or more EPs may be connected to one platform, and the platform side may use a plurality of RCs to communicate with the PCIe bridge controller 3.

In the following, each of the reference signs 21-1 to 21-8 or each of the reference signs A to H is used as a reference sign indicating a processor when it is needed to specify one of the processors. A reference sign 21 is used when indicating any one of processors.

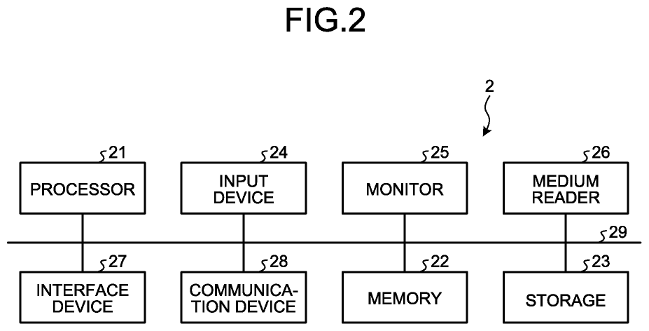

The platforms 2-1 to 2-8 are computer environments for performing arithmetic processing such as AI processing and image processing. In this regard, FIG. 2 is a diagram schematically illustrating a hardware structure of the platform 2 in the information processing system 1.

As illustrated in FIG. 2, the platform 2 includes a memory 22 for temporarily storing various kinds of information, and a storage 23. In addition, the platform 2 includes a processor 21 for executing various kinds of arithmetic processing, an input device 24 for receiving a data input, and a monitor 25. Furthermore, the platform 2 includes a medium reader 26 for reading a computer program or the like from a storage medium, an interface device 27 for connecting the platform 2 to various devices, and a communication device 28 for connecting the platform 2 in a wired or wireless manner to other information processing apparatuses or the like. Each of the devices 21 to 28 is connected to a bus 29.

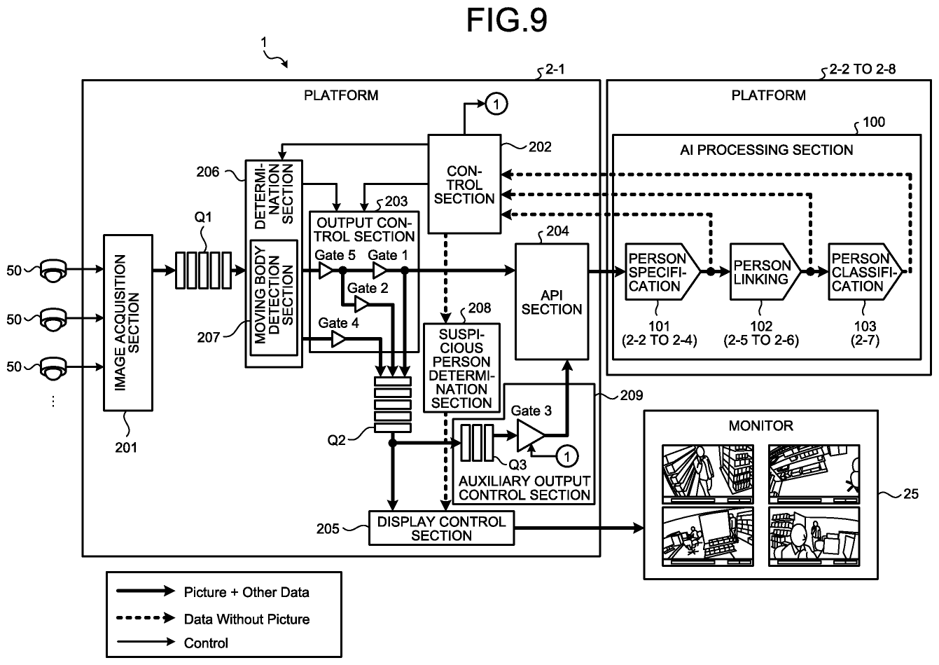

The input device 24 receives input of various kinds of information such as operation information from a manager of the platform 2. The monitor 25 displays various screens such as a display screen to the manager of the platform 2. For example, monitoring cameras (imaging devices) 50 (see FIG. 9), a printing device, and the like are connected to the interface device 27. The monitoring camera 50 is a data generating device for generating image data. The data generating device is not limited to the monitoring camera 50, and various devices for generating data subject to AI processing are applicable.

The memory 22 is a storage memory that includes a read only memory (ROM) and a random access memory (RAM). Various software programs and data and the like for those programs are written on the ROM of the memory 22. A software program on the memory 22 is read and executed by the processor 21 as appropriate. In addition, the RAM of the memory 22 is utilized as a primary storage memory or a working memory.

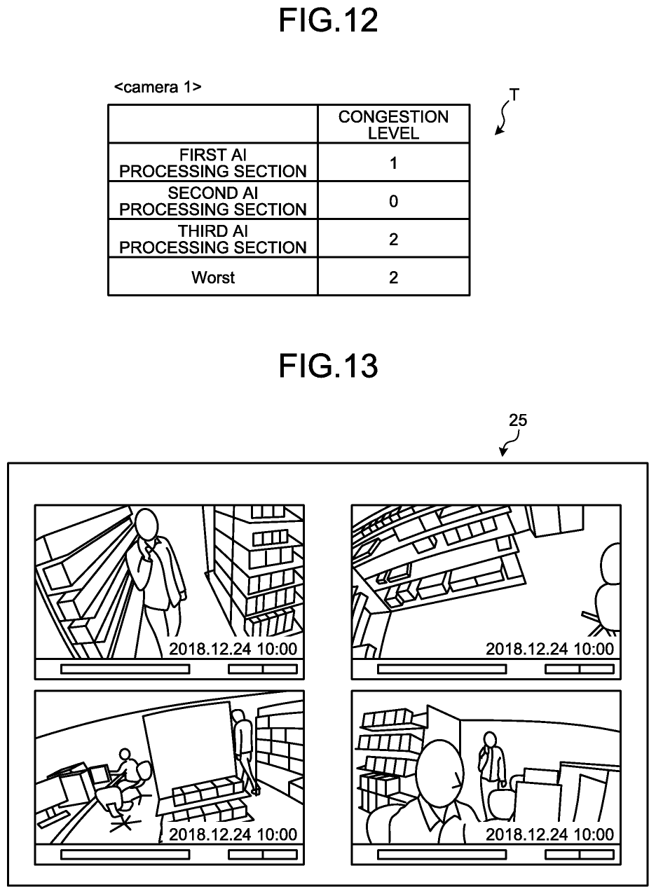

The storage 23 is a storage device such as a hard disk drive (HDD), a solid state drive (SSD), and a storage class memory (SCM), and it stores various kinds of data. Various software programs are also stored on the storage 23. In addition, various kinds of data such as a congestion level table T (see FIG. 12) are stored on the storage 23.

The processor 21 controls the entire platform 2. The processor 21 may be a multiprocessor. The processor 21 may be, for example, any one of a central processing unit (CPU), a micro-processing unit (MPU), a graphics processing unit (GPU), a digital signal processor (DSP), an application specific integrated circuit (ASIC), a programmable logic device (PLD), and a field programmable gate array (FPGA). In addition, the processor 21 may be a combination of two or more types of elements among the CPU, MPU, GPU, DSP, ASIC, PLD, and FPGA.

In the platform 2, the processor 21 executes the software program stored on the memory 22 and the storage 23 to provide various functions.

The above-described various software programs are not necessarily stored on the memory 22 and the storage 23. For example, the platform 2 may read and execute a computer program that is stored on a storage medium readable by the medium reader 26 of the platform 2. A storage medium that is readable by the platform 2 includes, for example, a CD-ROM or DVD disk, a portable recording medium such as a universal serial bus (USB) memory, a semiconductor memory such as a flash memory, and a hard disk drive. In addition, the information processing program may be stored on a device that is connected to a public line, the Internet, LAN, or the like, and the platform 2 may read out the information processing program therefrom for execution.

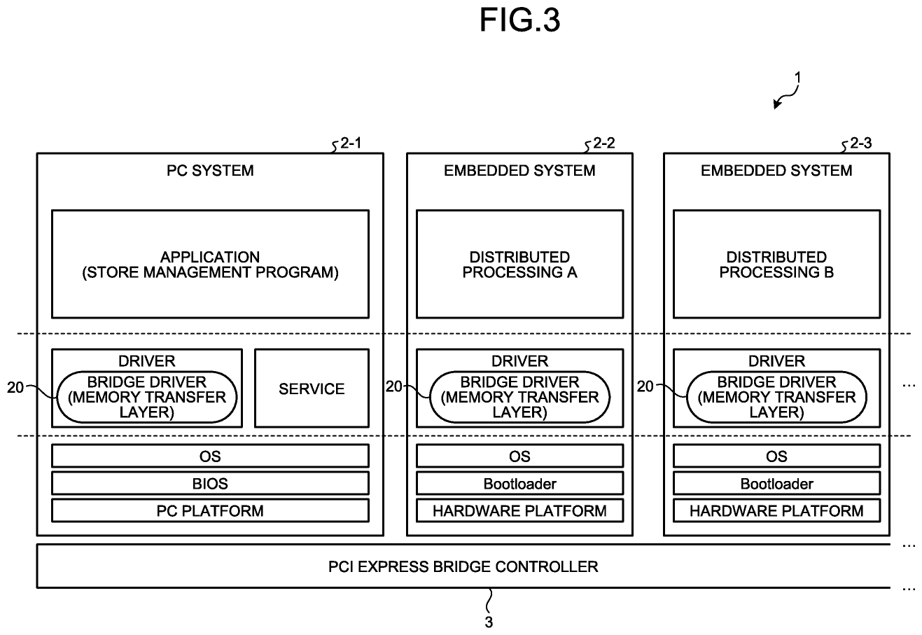

FIG. 3 is a diagram exemplifying a software configuration of the platform 2 in the information processing system 1. In FIG. 3, only the software configurations of the platforms 2-1 to 2-3 are illustrated for the purpose of convenience.

In the information processing system 1 illustrated in FIG. 3, the platform 2-1 is a general personal computer (PC) system, and Windows (registered trademark) is used as the operating system (OS). The platform 2-1 executes on this OS a store management program being an application program.

The platforms 2-2, 2-3 are embedded systems and each use Linux (registered trademark) as the OS. The platforms 2-2, 2-3 execute distributed processing programs (distributed processing A, B) of the AI processing on the OS.

Each platform 2 is provided with a bridge driver 20. The platform 2 communicates with the PCIe bridge controller 3 and other platforms 2 via the bridge driver 20. A communication method by the bridge driver 20 will be described later.

Each platform 2 includes the processor 21 and the memory (physical memory) 22, and the processor 21 executes the OS, various computer programs, drivers, and the like stored on the memory 22 to provide each function thereof.

The processors 21 provided for each platform 2 may be provided by different vendors from one another. In the example illustrated in FIG. 1, a platform having a plurality of RCs (for example, x86 processor of the Intel company) may be applied to part of the platforms 2 (for example, the platform 2-7).

In addition, the platforms 2 are each configured such that they are capable of independently operating so as not to affect other driver configurations.

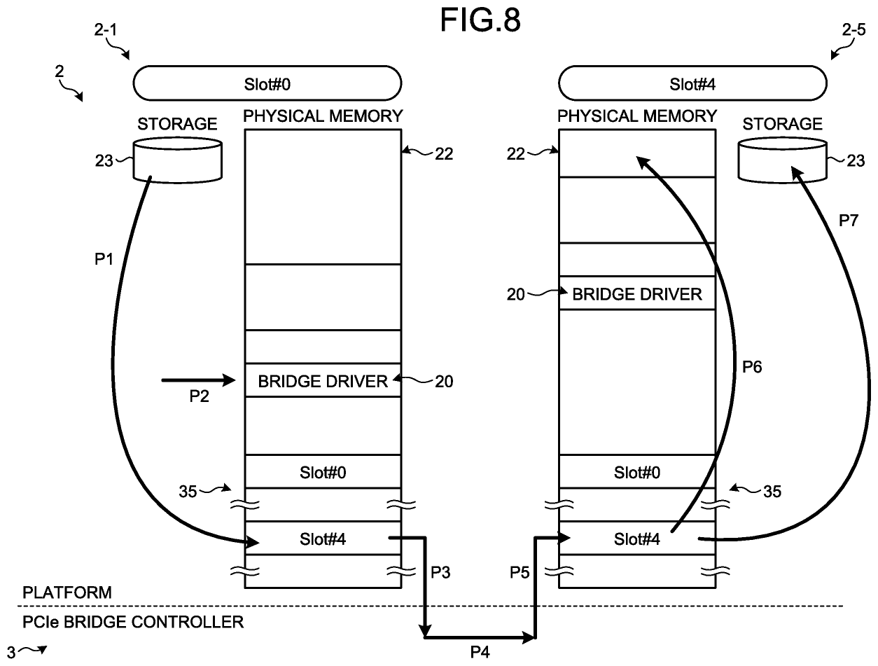

In the platform 2, part of the storage area of the memory 22 is used as a communication buffer 221 for temporarily storing data transferred between the platforms 2 (the processors 21), as will be described later with FIG. 8.

PCIe Bridge Controller

The PCIe bridge controller 3 implements data communication among the platforms 2-1 to 2-8.

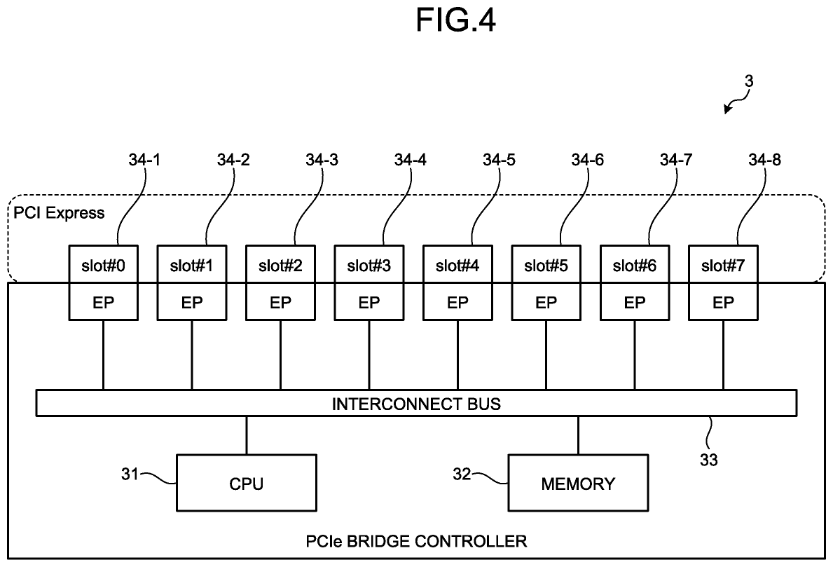

FIG. 4 is a diagram schematically illustrating a hardware structure of the PCIe bridge controller 3 in the information processing system 1.

The PCIe bridge controller 3 is, for example, a relay apparatus having 8-channel EP within one chip. As illustrated in FIG. 4, the PCIe bridge controller 3 includes a CPU 31, a memory 32, an interconnect bus 33, and a plurality (eight in the example illustrated in FIG. 4) of slots 34-1 to 34-8.

A device that is configured to satisfy the specification of PCIe is connected to each of the slots 34-1 to 34-8. In particular, in the information processing system 1, the platform 2 is connected to each of the slots 34-1 to 34-8.

In the following, reference signs 34-1 to 34-8 are used when it is needed to specify one of the slots. Reference sign 34 is used when indicating any of slots.

While one processor 21 may be connected to one slot 34, it is possible to connect one platform 2 to a plurality (for example, two) of the slots 34. Embodiments according to the present disclosure can be variously modified in this point.

By assigning two or more slots 34 to one platform 2, the platform 2 is allowed to perform communication using a wide communication band.

The slots 34 are each connected to the interconnect bus 33 via an internal bus. In addition, the CPU 31 and the memory 32 are connected to the interconnect bus 33. In this manner, each slot 34 is connected with the CPU 31 and the memory 32 in an inter-communicable manner via the interconnect bus 33.

The memory 32 is, for example, a storage memory (physical memory) including an ROM and a RAM. A software program related to data communication control, and data and the like for this program are written on the ROM of the memory 32. The software program on the memory 32 is read and executed by the CPU 31 as appropriate. In addition, the RAM of the memory 32 is utilized as a primary storage memory or working memory.

Furthermore, in the PCIe bridge controller 3, a memory area 35 (see FIG. 8) is provided correspondingly to each slot. In a base address register (BAR) space of the memory area 35, a storage area is provided for each slot. That is, in the BAR space of the memory area 35, storage areas corresponding to each of the slots #0 to #7 are provided.

As will be described later, in the PCIe bridge controller 3, data transfer between the platforms 2 is performed by using the storage area of each slot in the BAR space.

The CPU 31 controls the entire PCIe bridge controller 3. The CPU 31 may be a multiprocessor. Any one of MPU, GPU, DSP, ASIC, PLD, and FPGA may be used instead of the CPU 31. Alternatively, the CPU 31 may be a combination of two or more types of elements among CPU, MPU, GPU, DSP, ASIC, PLD, and FPGA.

The CPU 31 executes the software program stored on the memory 32 to provide data transfer between the platforms 2 (the processors 21) in the PCIe bridge controller 3.

The PCIe bridge controller 3 uses PCIe to speed up the data transfer between the platforms 2. As illustrated in FIG. 1, the PCIe bridge controller 3 operates each processor provided for each platform 2 as the RC, thereby providing data transfer between EPs operating as devices.

More specifically, in the information processing system 1, the processor of each platform 2 is operated as the RC of PCIe as a data transfer interface. In addition, the PCIe bridge controller 3, that is, the slot 34 connected to each platform 2, is caused to operate as the EP against each platform 2 (processor 21).

A method of connecting the PCIe bridge controller 3 as an EP to the processor 21 can be implemented by using various known techniques.

For example, at the time of connecting to the platform 2, the PCIe bridge controller 3 transmits to the processor 21 a signal indicating that the PCIe bridge controller 3 functions as an EP, thereby connecting to the processor 21.

In the PCIe bridge controller 3, tunneling of data is performed between an endpoint and an endpoint (EP to EP) to transfer data to RCs. A communication between the processors 21 is logically connected at the time of generation of transaction of PCIe. When data transfer is not concentrated on one processor 21, data transfer can be performed between each of the processors 21 in parallel.

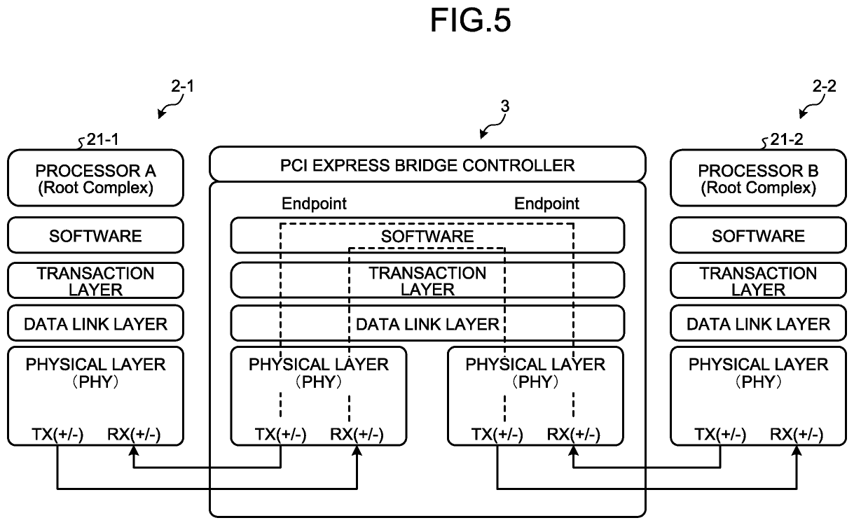

FIG. 5 is a diagram illustrating a layer configuration of PCIe. FIG. 5 illustrates an example of performing communication between the processor A of the platform 2-1 and the processor B of the platform 2-2.

In the platform 2-1 of the transmission source, data that is generated by the processor A being an RC is sequentially transferred through a software, a transaction layer, a data link layer, and a physical layer (PHY). After that, the data is transferred to a physical layer of the PCIe bridge controller 3 in the physical layer.

In the PCIe bridge controller 3, transfer is sequentially performed through the physical layer, the data link layer, the transaction layer, and the software. The data is transferred to the EP corresponding to the RC of the platform 2 of the destination by the tunneling.

That is, the data is transferred from one RC (processor 21) to other RCs (processors 21) by performing the tunneling of the data between the EPs in the PCIe bridge controller 3.

In the platform 2-2 of the destination, the data transferred from the PCIe bridge controller 3 is sequentially transferred through the physical layer (PHY), the data link layer, the transaction layer, and the software. The data is thereby transferred to the processor B of the platform 2-2 of the destination.

In the information processing system 1, a communication between the processors 21 (platforms 2) is logically connected at the time of generation of transaction of PCIe.

When data transfer to a specific processor 21 that is connected to one of the eight slots provided for the PCIe bridge controller 3 from other processors 21 is not concentrated, data transfer may be performed between any different pairs of processors 21 in parallel.

For example, when the processor B of the platform 2-2 and the processor C of the platform 2-3 both attempt to communicate with the processor A of the platform 2-1, the PCIe bridge controller 3 processes the communication of the processors B and C in serial.

However, as in the cases of the processors A and B, the processors C and D, and the processors E and F, when they each communicate with different processors and communications are not concentrated on a specific processor, the PCIe bridge controller 3 processes the communications between each pairs of the processors 21 in parallel.

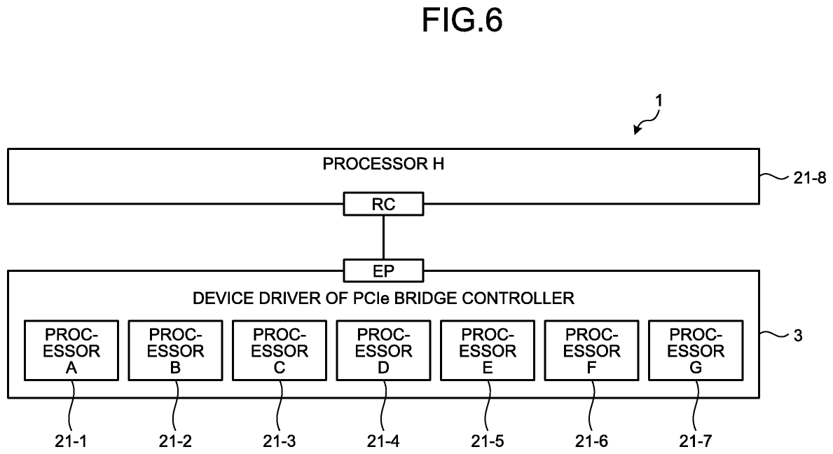

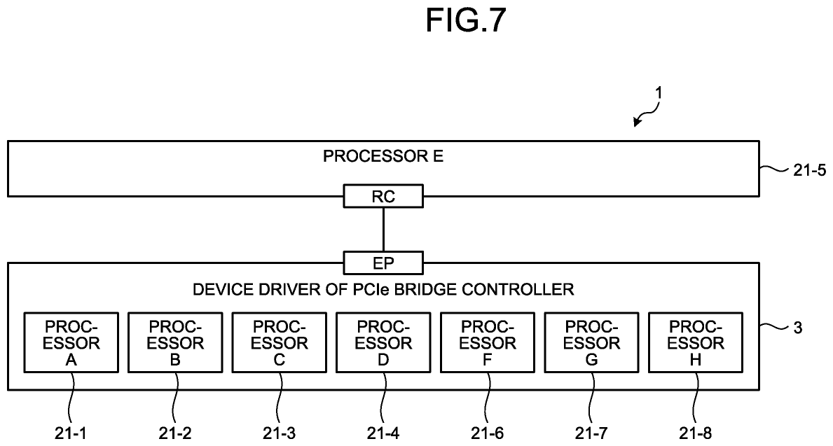

FIG. 6 is a diagram exemplifying how other processors 21 are seen from the processor 21-8 (processor H) in the information processing system 1. FIG. 7 is a diagram exemplifying how other processors 21 are seen from the processor 21-5 (processor E).

Even when communications are performed between each of the processors 21, only the PCIe bridge controller 3 can be seen from the OS (for example, a device manager of Windows) on each of the processors 21, and there is no need to directly manage other processors 21 being the connecting destinations. That is, the processor 21 of the connection destination of the PCIe bridge controller 3 should be managed with the device driver of the PCIe bridge controller 3.

Thus, there is no need to prepare device drivers for operating each of the processors 21 of the transmission source and the receiving destination, and communications between the processors 21 can be performed by only performing communication processing on the PCIe bridge controller 3 with the driver of the PCIe bridge controller 3.

Method of Data Transfer Between Processors

A method of data transfer between the processors 21 via the PCIe bridge controller 3 in the information processing system 1 as configured above will now be described.

In this regard, FIG. 8 is a diagram for explaining a method of data transfer between the processors 21 via the PCIe bridge controller 3 in the information processing system 1. The example illustrated in FIG. 8 describes a case in which data is transferred from the platform 2-1 connected with the slot #0 to the platform 2-5 connected with the slot #4.

The platform 2-1 of the data transmission source stores data (hereinafter, may be referred to as the transmission data) transmitted with a software program or the like from the storage 23 provided for the platform 2-1 into a memory area 35 of the platform 2-1 (P1 in FIG. 8). The memory area 35 may be part of the communication buffer 221. The memory area 35 is an area that is provided for each of the platforms 2 in the same size as the memory 22. The memory area 35 is partitioned in accordance with the number of slots. Each partitioned storage area of the memory area 35 is associated with any one of the slots. For example, the storage area denoted a Slot #0 within the memory area 35 is associated with the platform 2-1 connected to the Slot #0, and the storage area denoted a Slot #4 within the memory area 35 is associated with the platform 2-5 connected to the Slot #0. The platform 2-1 stores transmission data in an area (in this case, the Slot #4) assigned to the slot of the destination among the memory area 35.

The bridge driver 20 acquires or generates slot information representing a slot of the destination and address information representing an address of the partitioned area in the memory area 35 of the destination, based on the storage area in the memory area 35 of the platform 2 (P2 in FIG. 8).

In the transmission source EP, the bridge driver 20 passes transfer data including slot information, address information, and transmission data, to the PCIe bridge controller 3 as a relay apparatus (P3 in FIG. 8). The PCIe bridge controller 3 connects, based on the slot information, the slot of the transmission source with the slot of the destination by the EP to EP communication, thereby transferring the transfer data to the platform 2-4 of the destination (P4 in FIG. 8).

The bridge driver 20 of the destination stores the transmission data (or the transfer data) in an area of an address indicated by the address information within the storage area corresponding to the slot #4 of the memory area 35 in the platform 2 of the destination, based on the slot information and the address information (P5 in FIG. 8).

In the destination platform 2, a computer program is executed to read out transmission data stored in the memory area 35 and store the transmit data into the memory (local memory) 22 or the storage 23 (P6 and P7 in FIG. 8).

In the manner described above, data (the transfer data) is transferred from the platform 2-1 as the transfer source to the platform 2-5 as the transfer destination.

In the information processing system 1, data transfer is mediated between the EPs within the PCIe bridge controller 3. Accordingly, data transfer between the RCs (processors 21) connected to the PCIe bridge controller 3 can be implemented.

That is, each of the processors 21 is independently operated as an RC of PCIe, and in the PCIe bridge controller 3, devices connecting to each of the processors 21 are connected as EPs to perform data transfer between the EPs. Therefore, a problem due to a device driver can be avoided, and high-speed data transfer can be operated as one system.

In addition, data transfer between different processors 21 is enabled as long as a data communication function complying with the specification of PCIe is provided. Therefore, it is possible to increase the options of the processor 21 to be used regardless of the presence or absence of a device driver, support OS, and the like.

Since each of the processors 21 is connected via the PCIe bridge controller 3 serving as an EP, there is no need to add a device driver of the RC ahead the EP. Accordingly, development of a device driver is unnecessary, and a defect due to addition of a device driver will not occur.

Characteristic Function of Information Processing System 1

A characteristic function of the information processing system 1 according to the present embodiment among the functions provided with the processor 21 by the OS and the software installed in the storage 23 of the platforms 2-1 to 2-7 will be described. In the following, it is assumed that the platform 2-8 is not connected to the slot 34-8.

FIG. 9 is a functional block diagram illustrating a function in the information processing system 1. In FIG. 9, the PCIe bridge controller 3 is omitted.

The platforms 2-2 to 2-7 execute a distributed processing program of AI processing for monitoring a store or the like using machine learning, especially a deep learning technique.

As illustrated in FIG. 9, each of the platforms 2-2 to 2-7 operates as an AI processing section 100. The AI processing section 100 executes AI processing such as a person recognition utilizing the deep learning technique on image data acquired from the monitoring camera 50. More specifically, the AI processing section 100 distributes and executes AI processing such as person specification processing, person linking processing, and person classification processing for monitoring in a store or the like.

The person specification processing is executed to specify a person, parts constituting the person, types of belongings, and detection coordinates thereof from image data captured by a plurality of the monitoring cameras 50. As illustrated in FIG. 9, the platforms 2-2 to 2-4 execute the person specification processing. That is, the platforms 2-2 to 2-4 constitute a first AI processing section 101 that is in charge of the person specification processing.

The person linking processing is executed to link specified people in time series. As illustrated in FIG. 9, the platforms 2-5 to 2-6 execute the person linking processing. That is, the platforms 2-5 to 2-6 constitute a second AI processing section 102 that is in charge of the person linking processing.

The person classification processing classifies the linked people in time series. As illustrated in FIG. 9, the platform 2-7 performs the person classification processing. That is, the platform 2-7 constitutes a third AI processing section 103 that is in charge of the person classification processing.

The platform 2-1 executes the store management program.

The platform 2-1 outputs image data captured by the monitoring cameras 50 to the platforms 2-2 to 2-7. In addition, the platform 2-1 concurrently displays the image data captured by the monitoring cameras 50 on the monitor 25.

As illustrated in FIG. 9, the platform 2-1 includes an image acquisition section 201, a control section 202, an output control section 203, an application programming interface (API) section 204, a display control section 205, a determination section 206, a moving body detection section 207, a suspicious person determination section 208, and an auxiliary output control section 209.

The image acquisition section 201 acquires the image data from the monitoring camera 50. The image acquisition section 201 sequentially accumulates the acquired image data in a queue Q1.

The application programming interface (API) section is an interface for providing data from the platform 2-1 to the platforms 2-2 to 2-7.

The control section 202 monitors progress condition of AI processing in the AI processing section 100. When the progress condition of AI processing in the AI processing section 100 is not congested, the control section 202 controls the output control section 203 so as to pass the image data to the AI processing section 100. When the progress condition of AI processing in the AI processing section 100 is congested, the control section 202 controls the output control section 203 so as not to pass the image data to the AI processing section 100.

For example, the control section 202 monitors the number of images that are waiting for processing in the AI processing section 100 (queue information) and determines the progress condition of AI processing. Specifically, the control section 202 determines the congestion level based on whether the number of images, which are waiting for processing, is larger or smaller than a threshold of the number of images previously set.

In addition, for example, the control section 202 may determine the progress condition of AI processing by monitoring the processing time from the API section 204 to the platforms 2-2 to 2-7. Specifically, the control section 202 determines the congestion level based on whether the time taken for processing is longer or shorter than a predetermined threshold of time.

The output control section 203 controls ON/OFF of Gate 1, Gate 2, Gate 4, and Gate 5. The control is performed such that, when the control section 202 determines that the AI processing section 100 is not congested, image data is output to the AI processing section 100, and when the control section 202 determines that the AI processing section 100 is congested, output of image data to the AI processing section 100 is skipped.

In addition, when the control section 202 determines that the AI processing section 100 is not congested, the output control section 203 sorts and accumulates the skipped image data into a queue Q2 that is an accumulation section.

The auxiliary output control section 209 accumulates, in a queue Q3, the skipped image data sorted into the queue Q2. In addition, when the congestion level of the AI processing section 100 determined by the control section 202 satisfies a predetermined condition, the auxiliary output control section 209 controls ON/OFF of Gate 3 to output the image data accumulated in the queue Q3 to the AI processing section 100.

The display control section 205 discriminates the image data accumulated in the queue Q2 for each monitoring camera 50, and concurrently displays the image data on the monitor 25. Furthermore, the display control section 205 displays other image data on the monitor 25 concurrent with the image data on which AI processing has been performed in the AI processing section 100.

The determination section 206 determines, based on the result of performing AI processing in the AI processing section 100, whether a person is continuously undetected for n frames or more in the image data.

When the determination section 206 determines that a person is continuously undetected for n frames or more, the output control section 203 stops transfer of the image data to the AI processing section 100. In addition, the output control section 203 sorts and accumulates the image data, for which transfer to the AI processing section 100 is stopped, into the queue Q2.

The moving body detection section 207 detects a moving object among frames of the image data. The output control section 203 controls ON/OFF of Gate 4 and Gate 5 to stop transfer of the image data to the AI processing section 100 until a moving object is newly detected with the moving body detection section 207. For example, when the moving body detection section 207 detects a moving object, the output control section 203 turns on Gate 4 and turns off Gate 5 to stop transfer of the image data to the AI processing section 100. When the moving body detection section 207 does not detect a moving object, the output control section 203 transfers the image data to the AI processing section 100 by turning off Gate 4 and turning on Gate 5.

The moving body detection section 207 detects a moving object by, for example, taking a difference between image data that is newly acquired from the monitoring camera 50 and image data that is one frame before the image data. In addition, the moving body detection section 207 detects a moving object by, for example, taking a difference between image data that is being processed and image data that is several frames before the image data.

The suspicious person determination section 208 determines a suspicious person based on a result of performing AI processing in the AI processing section 100.

Explanation on Processing

By the way, when performing real-time AI processing on an analysis of characteristics of a person who appears in images captured by the monitoring cameras 50, there is a problem in that a delay will occur when the amount of arithmetic operations becomes extremely large.

Thus, in the present embodiment, the platforms 2-2 to 2-7 perform feedback of the congestion state of each AI processing in the platforms 2-2 to 2-7 to the PC platform 2 (platform 2-1).

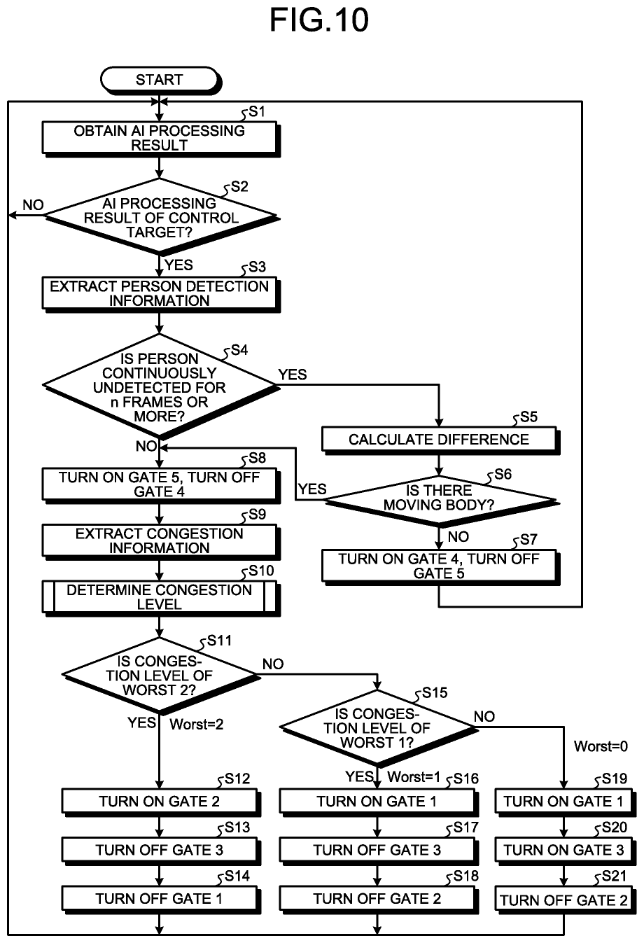

FIG. 10 is a flowchart illustrating a flow of processing in the platform 2-1 as an information processing apparatus. As illustrated in FIG. 10, the control section 202 obtains an AI processing result from the AI processing section 100 (Step S1). The control section 202 obtains, from the AI processing section 100, for example, an AI processing result in which a time stamp in a JavaScript (registered trademark) object notation (JSON) form is given. The AI processing result in the JSON form includes the time required for AI processing or queue information of the AI processing section 100 (the first AI processing section 101, the second AI processing section 102, and the third AI processing section 103) as congestion information.

Subsequently, the control section 202 determines whether the obtained AI processing result is the AI processing result of an image of the monitoring camera 50 being the control target (Step S2).

When the control section 202 determines that it is not the AI processing result of the image of the monitoring camera 50 that is the control target (No at Step S2), the processing is returned to Step S1.

On the other hand, when the control section 202 determines that it is the AI processing result of the image of the monitoring camera 50 that is the control target (Yes at Step S2), person detection information is extracted from the AI processing result (Step S3).

The determination section 206 determines whether a person (detection target) is continuously undetected for n frames or more (Step S4). The determination as to whether a person is continuously undetected for n frames or more is performed based on the AI processing result of performing AI processing on the AI processing section 100 side. For example, when a person is continuously undetected for three frames, a non-detection flag is set to 1. AI processing on the AI processing section 100 side may perform detection regardless of whether a person stays still or is moving.

When the determination section 206 determines that a person is continuously undetected for n frames or more (Yes at Step S4), the degree of a pixel difference among frames is calculated to detect a moving body (Step S5), and the processing is forwarded to Step S6.

Specifically, the determination section 206 takes a difference between image data that is newly acquired from the monitoring camera 50 and image data that is one frame before. Thus, a moving object can be detected without using a large amount of memory. When there is a moving object, a pixel difference becomes large in a part where the moving object appears. Since an image can be expressed by matrixes, the difference can be recognized by subtracting matrixes.

The determination section 206 may take a difference between image data that is newly acquired from the monitoring camera 50 and image data that is several frames before. In this manner, detection accuracy of the moving object can be improved.

On the other hand, when the determination section 206 determines that a person is not continuously undetected for n frames or more (No at Step S4), the processing is forwarded to Step S8.

The moving body detection section 207 determines whether there is a moving body based on the degree of a pixel difference detected at Step S5 (Step S6).

When the moving body detection section 207 determines that there is no moving body (No at Step S6), the output control section 203 turns on Gate 4 and turns off Gate 5 to sort the image data into the queue Q2 (Step S7). The processing is returned to Step S1. That is, No at Step S6 represents “a person is not present” and “there is no moving object”, so that transfer of an image to the AI processing section 100 will be stopped until appearance of a new moving object.

The reason for the above operation is that, in a case where AI processing such as person detection is constantly performed even when a person does not appear in the image at all, there arises problems including increase of traffic due to image transfer and increase of a load of arithmetic operations for AI processing of the AI processing section 100. Such problems will worsen throughput of the entire system.

Furthermore, when there are multiple monitoring cameras 50, images captured by each of the monitoring cameras 50 will be processed as the entire system by sharing the AI processing section 100. Thus, in view of maintenance of real-time property, it is desirable to perform AI processing only on an image in which a person is present.

When the determination section 206 determines that a person is not continuously undetected for n frames or more (No at Step S4), and the moving body detection section 207 determines that there is a moving body (Yes at Step S6), the output control section 203 turns on Gate 5 and turns off Gate 4 to sort the image data into Gate 1 and Gate 2 (Step S8). Then, the processing is forwarded to Step S9.

That is, when a person is not continuously undetected for n frames or more, or when there is a moving body, there is a high possibility of a person being present within an image. Thus, control is performed such that the image can reach the AI processing section 100.

In this manner, traffic and a load of arithmetic operations of the AI processing section 100 can be reduced by stopping AI processing on an image of a specific one of the monitoring cameras 50. By reducing traffic, throughput of the entire system can be improved, and undesired skip processing, which will be described later, can be decreased. In addition, at the time of an increased load such as there are many people appearing on other monitoring cameras 50, a computer resource that is obtained by reducing the load of arithmetic operations of the AI processing section 100 can be assigned.

Subsequently, the control section 202 extracts the time required for AI processing or queue information of the AI processing section 100 as congestion information by JSON (Step S9).

Then, the control section 202 performs processing of determining the congestion level of the AI processing section 100 (Step S10).

As described above, the control section 202 monitors the number of images that are waiting for processing in the AI processing section 100 (queue information) and determines the progress condition of AI processing. Specifically, the control section 202 determines the congestion level based on whether the number of images that are waiting for processing is larger or smaller than a threshold of the number of images previously set.

Alternatively, for example, the control section 202 may determine the progress condition of AI processing by monitoring the processing time from the API section 204 to the platforms 2-2 to 2-7. Specifically, the control section 202 determines the congestion level based on whether the time taken for processing is longer or shorter than a threshold of the time previously set.

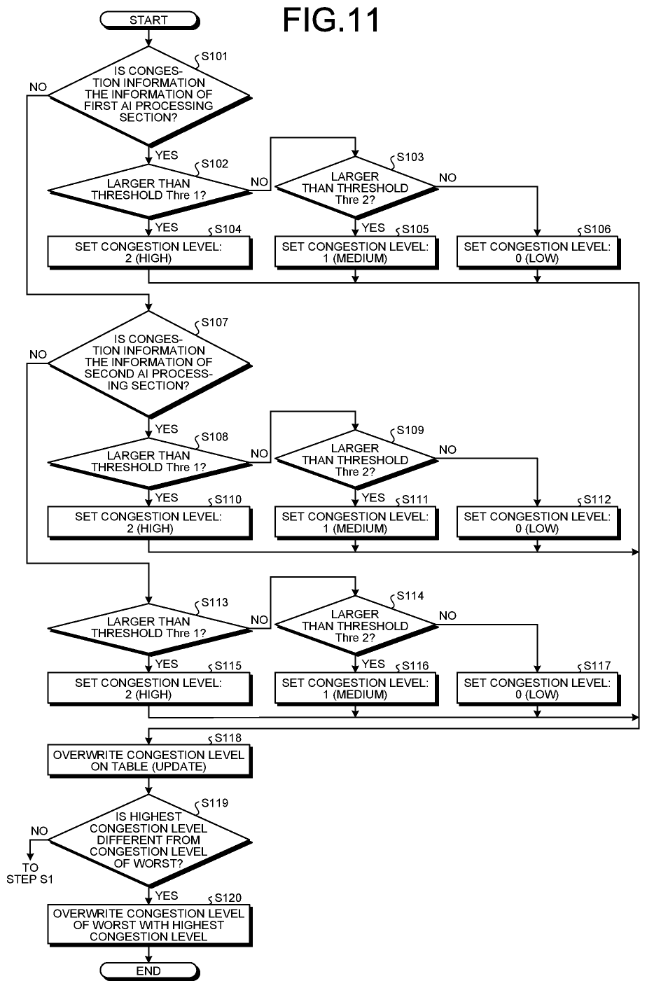

FIG. 11 is a flowchart illustrating a flow of processing of determining the congestion level of the AI processing section 100.

As illustrated in FIG. 11, the control section 202 determines whether the congestion information is information of the first AI processing section 101 (Step S101).

When the congestion information is information of the first AI processing section 101 (Yes at Step S101), the control section 202 determines whether the congestion state is larger than a threshold Thre1 for the first AI processing section 101 (Step S102) and determines whether the congestion state is larger than a threshold Thre2 (Thre1>Thre2) for the first AI processing section 101 (Step S103).

When the congestion state is larger than the threshold Thre1 for the first AI processing section 101 (Yes at Step S102), the control section 202 sets a congestion level “2” (high) for the first AI processing section 101 (Step S104), and the processing is forwarded to Step S118.

When the congestion state is not larger than the threshold Thre1 and is larger than the threshold Thre2 for the first AI processing section 101 (No at Step S102 and Yes at Step S103), the control section 202 sets a congestion level “1” (medium) for the first AI processing section 101 (Step S105), and the processing is forwarded to Step S118.

When the congestion state is not larger than the threshold Thre1 and is not larger than the threshold Thre2 for the first AI processing section 101 (No at Step S102 and No at Step S103), the control section 202 sets a congestion level “0” (low) for the first AI processing section 101 (Step S106), and the processing is forwarded to Step S118.

In addition, when the congestion information is not information of the first AI processing section 101 (No at Step S101), the control section 202 determines whether the congestion information is information of the second AI processing section 102 (Step S107).

When the congestion information is information of the second AI processing section 102 (Yes at Step S107), the control section 202 determines whether the congestion state is larger than a threshold Thre1 for the second AI processing section 102 (Step S108) and determines whether the congestion state is larger than a threshold Thre2 (Thre1>Thre2) for the second AI processing section 102 (Step S109).

When the congestion state is larger than the threshold Thre1 for the second AI processing section 102 (Yes at Step S108), the control section 202 sets the congestion level “2” (high) for the second AI processing section 102 (Step S110), and the processing is forwarded to Step S118.

When the congestion state is not larger than the threshold Thre1 and is larger than the threshold Thre2 for the second AI processing section 102 (No at Step S108 and Yes at Step S109), the control section 202 sets the congestion level “1” (medium) for the second AI processing section 102 (Step S111), and the processing is forwarded to Step S118.

When the congestion state is not larger than the threshold Thre1 and is not larger than the threshold Thre2 for the second AI processing section 102 (No at Step S108 and No at Step S109), the control section 202 sets a congestion level “0” (low) for the second AI processing section 102 (Step S112), and the processing is forwarded to Step S118.

Furthermore, when the congestion information is not information of the first AI processing section 101, and the congestion information is not information of the second AI processing section 102 (No at Step S101 and No at Step S107), the control section 202 determines whether the congestion state is larger than a threshold Thre1 for the third AI processing section 103 (Step S113) and determines whether the congestion state is larger than a threshold Thre2 (Thre1>Thre2) for the third AI processing section 103 (Step S114).

When the congestion state is larger than the threshold Thre1 for the third AI processing section 103 (Yes at Step S113), the control section 202 sets the congestion level “2” (high) for the third AI processing section 103 (Step S115), and the processing is forwarded to Step S118.

When the congestion state is not larger than the threshold Thre1 and is larger than the threshold Thre2 for the third AI processing section 103 (No at Step S113 and Yes at Step S114), the control section 202 sets the congestion level “1” (medium) for the third AI processing section 103 (Step S116), and the processing is forwarded to Step S118.

When the congestion state is not larger than the threshold Thre1 and is not larger than the threshold Thre2 for the third AI processing section 103 (No at Step S113 and No at Step S114), the control section 202 sets the congestion level “0” (low) for the third AI processing section 103 (Step S117), and the processing is forwarded to Step S118.

Furthermore, the control section 202 overwrites the congestion level on the table T for update (Step S118). FIG. 12 is a diagram illustrating the exemplary congestion level table T. As illustrated in FIG. 12, the congestion level table T is provided for each monitoring camera 50. According to the example illustrated in FIG. 12, the congestion level of the first AI processing section 101 is the congestion level “1” (medium), the congestion level of the second AI processing section 102 is the congestion level “0” (low), and the congestion level of the third AI processing section 103 is the congestion level “2” (high). In addition, Worst in the congestion level table T is the highest congestion level of the first AI processing section 101 to the third AI processing section 103.

The control section 202 determines whether the highest congestion level of the first AI processing section 101 to the third AI processing section 103 is different from the congestion level of Worst of the congestion level table T (Step S119).

When the highest congestion level of the first AI processing section 101 to the third AI processing section 103 is different from the congestion level of Worst of the congestion level table T (Yes at Step S119), the control section 202 overwrites the congestion level of Worst with the highest congestion level of the first AI processing section 101 to the third AI processing section 103 (Step S120).

When the highest congestion level of the first AI processing section 101 to the third AI processing section 103 is the same as the congestion level of Worst of the congestion level table T (No at Step S119), the control section 202 does not overwrite the congestion level of Worst, and the processing is returned to Step S1.

The processing of determining the congestion level of the AI processing section 100 is now completed.

Returning to FIG. 10, the output control section 203 and the auxiliary output control section 209 determine whether the congestion level of Worst of the congestion level table T is “2” (Step S11).

When the congestion level of Worst of the congestion level table T is “2” (Yes at Step S11), the output control section 203 and the auxiliary output control section 209 turn on Gate 2 (Step S12), turn off Gate 3 (Step S13), and turn off Gate 1 (Step S14). The processing is returned to Step S1.

When the congestion level of Worst of the congestion level table T is not “2” (No at Step S11), the output control section 203 and the auxiliary output control section 209 determine whether the congestion level of Worst is “1” (Step S15).

When the congestion level of Worst of the congestion level table T is “1” (Yes at Step S15), the output control section 203 and the auxiliary output control section 209 turn on Gate 1 (Step S16), turn off Gate 3 (Step S17), and turn off Gate 2 (Step S18). The processing is returned to Step S1.

When the congestion level of Worst of the congestion level table T is not “1” (No at Step S15), the output control section 203 and the auxiliary output control section 209 turn on Gate 1 (Step S19), turn on Gate 3 (Step S20), and turn off Gate 2 (Step S21). The processing is returned to Step S1.

At Steps S12 to S14, Steps S16 to S18, and Steps S19 to S21, control orders are set such that all gates are not turned off when the gates cannot be turned on/off at the same time. However, when Gate 1 and Gate 2 are turned on at a certain moment, Gate 2 takes priority. In addition, when Gate 4 and Gate 5 are turned on at a certain moment, Gate 5 takes priority.

As indicated at Step S20, when the congestion level of Worst of the congestion level table T is not “1”, the auxiliary output control section 209 turns on Gate 3. By this operation, the auxiliary output control section 209 transfers an image for which transfer is skipped to the AI processing section 100 when the congestion level of the AI processing section 100 is sufficiently low, thereby executing AI processing in the AI processing section 100 with a delay.

In the present embodiment, the output control section 203 controls output of image data for each monitoring camera 50, which is a data generating device. Alternatively, the output control section 203 may control output of image data of all the monitoring cameras 50.

Additionally, the display control section 205 discriminates the image data accumulated in the queue Q2 for each monitoring camera 50, and concurrently displays the image data on the monitor 25. In this regard, when concurrently displaying image data captured by the monitoring cameras 50 on the monitor 25, there is a problem in that the degree of a delay in AI processing among the monitoring cameras 50 becomes visible to a user.

FIG. 13 is a diagram illustrating a display example on the monitor 25. The display control section 205 displays other image data on the monitor 25 concurrent with the image data on which AI processing has been performed in the AI processing section 100, based on the AI processing result in the JSON form for which a time stamp is given and the suspicious person determination result in the suspicious person determination section 208. Thereby, a deviation in a time axis of the display images is suppressed. As illustrated in FIG. 13, the times of each image data displayed on the monitor 25 are concurrent with each other.

In this manner, even when concurrently displaying image data captured by the monitoring cameras 50 on the monitor 25, the degree of delay in AI processing among the monitoring cameras 50 is not visible to a user.

As described above, according to the present embodiment, when performing AI real-time processing, real-time operations of the entire system can be maintained even if the amount of arithmetic operations becomes large.

In addition, according to the present embodiment, real-time AI processing is continuously performed, and results of AI processing can also be obtained for images/frames that are sacrificed (AI processing cannot be performed) for maintenance of such real-time AI processing.

Furthermore, according to the present embodiment, sufficiency of the performance of an AI processing processor directed to real-time processing can be measured by recording whether AI processing has been performed real time.

Moreover, according to the present embodiment, by stopping AI processing on image data of a specific one of the monitoring cameras, traffic and a load of arithmetic operations of the AI processing section 100 can be reduced. By reducing traffic, throughput of the entire system can be improved, and undesired skip processing can be decreased. In addition, at the time of an increased load such as there are many people appearing on other monitoring cameras 50, a computer resource that is obtained by reducing the load of arithmetic operations of the AI processing section 100 can be assigned.

The disclosed technique is not limited to the above-described embodiment, and various modifications can be made within a scope that does not deviate from the spirit of the present embodiment. Each configuration and each processing in the present embodiment may be selected as necessary, or may be combined as appropriate.

For example, in the configuration illustrated in FIG. 4, the PCIe bridge controller 3 includes eight slots 34-1 to 34-8. Alternatively, the PCIe bridge controller 3 can be provided through various modifications. That is, the PCIe bridge controller 3 may include seven or less, or nine or more of the slots 34.

The above-described embodiment mentions PCIe as an example of an I/O interface of each section. However, the I/O interface is not limited to PCIe. For example, the I/O interface of each section is only required to be a technique that enables data transfer between a device (peripheral controller) and a processor by a data transfer bus. The data transfer bus may be a general-purpose bus that is capable of transferring data at high speed in a local environment provided for one housing or the like (for example, one system or one apparatus). The I/O interface may be either of a parallel interface and a serial interface.

The I/O interface may have a configuration that is capable of performing point-to-point connection and packet-based serial transfer of data. The I/O interface may include a plurality of lanes in the case of serial transfer. The layer structure of the I/O interface includes a transaction layer that performs generation and decryption of packets, a data link layer that performs error detection and the like, and a physical layer that converts serial and parallel. In addition, the I/O interface may include a root complex that is an uppermost layer having one or a plurality of ports, an endpoint that is an I/O device, a switch for increasing the ports, a bridge for converting protocols, and the like. The I/O interface may multiplex data and a clock signal to be transmitted with a multiplexer for transmission. In this case, the receiving side may separate the data and the clock signal with a demultiplexer.

What is claimed is:

1. An information processing apparatus comprising:
a memory; and
a hardware processor coupled to the memory, and the hardware processor:
monitors progress condition of AI processing in an AI processing device performing the AI processing;
outputs data generated by one or more data generating devices to the AI processing device when it is determined that the AI processing device is not congested; and
skips output of the data to the AI processing device when it is determined that the AI processing device is congested.

2. The information processing apparatus according to claim 1, wherein the hardware processor further accumulates skipped data in the memory when it is determined that the AI processing device is not congested.

3. The information processing apparatus according to claim 2, wherein the hardware processor further outputs the data accumulated in the memory to the AI processing device when a congestion level of the AI processing device satisfies a predetermined condition.

4. The information processing apparatus according to claim 3, wherein the predetermined condition is a condition stricter than a condition that is applied when determining non-congestion at the time of determination on the congestion level of the AI processing device.

5. The information processing apparatus according to claim 1, wherein
two or more of the data generating devices are present, and
the hardware processor controls output of data for each of the two or more data generating devices.

6. The information processing apparatus according to claim 1, wherein
two or more of the data generating devices are present, and
the hardware processor controls output of data of entirety of the two or more data generating devices.

7. The information processing apparatus according to claim 2, wherein
two or more of the data generating devices are present,
the memory accumulates data generated by the two or more data generating devices in addition to the skipped data,
the hardware processor further:
discriminates the data accumulated in the memory for each of the two or more data generating devices and concurrently displays the data; and
displays other data concurrent with the data on which AI processing has been performed in the AI processing device.

8. The information processing apparatus according to claim 1, wherein
the data generated by the one or more data generating devices is image data captured by one or more imaging devices,
the hardware processor further:
determines, based on a result of performing AI processing in the AI processing device, whether a detection target is continuously undetected for n frames or more with respect to the image data; and
stops transfer of the image data to the AI processing device when it is determined that the detection target is continuously undetected for n frames or more.

9. The information processing apparatus according to claim 8, wherein the hardware processor further:
detects a moving object that is present among the frames of the image data; and
stops transfer of the image data to the AI processing device until a moving object is newly detected.

10. The information processing apparatus according to claim 9, wherein the hardware processor detects the moving object by taking a difference between image data that is newly acquired from the imaging device and image data that is one frame before the image data.

11. The information processing apparatus according to claim 9, wherein the hardware processor detects the moving object by taking a difference between image data that is newly acquired from the imaging device and image data that is several frames before the image data.

12. The information processing apparatus according to claim 8, wherein the hardware processor accumulates, in the memory, image data for which transfer to the AI processing device is stopped.

13. An information processing system comprising:
the information processing apparatus according to claim 1, which acquires the data generated by the one or more data generating devices; and
an AI processing device that performs AI processing on the data output from the information processing apparatus, the AI processing device performing feedback of a congestion state of AI processing to the information processing apparatus.

14. The information processing system according to claim 13, wherein
the data generated by the one or more data generating devices is image data captured by one or more imaging devices, and
the AI processing device adds, to a result of AI processing on the information processing apparatus, information on whether a detection target is continuously undetected for n frames or more with respect to the image data.

15. A computer program product comprising a non-transitory computer-readable recording medium on which an executable program is recorded, the program instructing a computer to:
monitor progress condition of AI processing in an AI processing device performing the AI processing; and
as a result of the monitoring:
output data generated by one or more data generating devices to the AI processing device when it is determined that the AI processing device is not congested; and
skip output of the data to the AI processing device when it is determined that the AI processing device is congested.

16. The computer program product according to claim 15, wherein
the data generated by the one or more data generating devices is image data captured by one or more imaging devices, and
the program further instructs the computer to:
determine, based on a result of performing the AI processing in the AI processing device, whether a detection target is continuously undetected for n frames or more with respect to the image data; and
stop transfer of the image data to the AI processing device when it is determined that the detection target is continuously undetected for n frames or more.
